(19) United States
(12) Patent Application Publication
(10) Pub. No.: US 2015/0356068 A1
(43) Pub. Date: Dec. 10, 2015

(54) AUGMENTED DATA VIEW

(71) Applicant: Microsoft Technology Licensing, LLC, Redmond, WA (US)

(72) Inventors: Brian T. Hill, Duvall, WA (US); Benjamin E. Rampson, Woodinville, WA (US); Andrew G. Carlson, Redmond, WA (US); Christopher J. Gross, Redmond, WA (US); Poornima Hanumara, Seattle, WA (US)

(21) Appl. No.: 14/297,800

(22) Filed: Jun. 6, 2014

(51) Int. Cl. G06F 17/24; G06F 3/0484; G06F 3/0482

(52) U.S. Cl. CPC G06F 17/245; G06F 3/0482; G06F 3/04842

(57) ABSTRACT

A view of data is captured on a mobile device. The view of data can be presented to an augmented visualization system and augmented visualizations for the data are received from the augmented visualization system. The augmented visualization is displayed on the mobile device.

### BACKGROUND

Computer systems are currently in wide use. Many computer systems are used in business and other environments where data is generated or presented for review.

The quantity and complexity of the available data sources can make it difficult to derive insights from data. In addition, many data sources present data in a numeric fashion, but other types of data visualizations (such as charts or graphs) can present insight as well.

Some computer systems do provide various visualizations of data. Users navigate through a variety of different user experiences in order to input data into the system so that it can be visualized using those different visualizations.

Some types of data analyses involve a relatively large amount of data. The data can be large enough so that it cannot be displayed on a single screen. Therefore, even if a user does know how to generate a visualization of that data, the user may not be able to see both the visualization and the numerical data, at the same time.

The discussion above is merely provided for general background information and is not intended to be used as an aid in determining the scope of the claimed subject matter.

### SUMMARY

A view of data is captured on a mobile device. The view of data can be presented to an augmented visualization system and augmented visualizations for the data are received from the augmented visualization system. The augmented visualization is displayed on the mobile device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of an augmented visualization system.

FIG. 2 is a flow diagram illustrating one example of the operation of the system shown in FIG. 1 in generating augmented views of data.

FIG. 3 shows an augmented visualization architecture in which the augmented visualization system shown in FIG. 1 is distributed among various devices.

FIGS. 4A and 4B are examples of user interface displays.

FIG. 5 shows one example of the architecture shown in FIG. 3, deployed in a cloud computing architecture.

FIGS. 6-8 show various examples of mobile devices.

FIG. 9 is a block diagram of one example of a computing environment.

### DETAILED DESCRIPTION

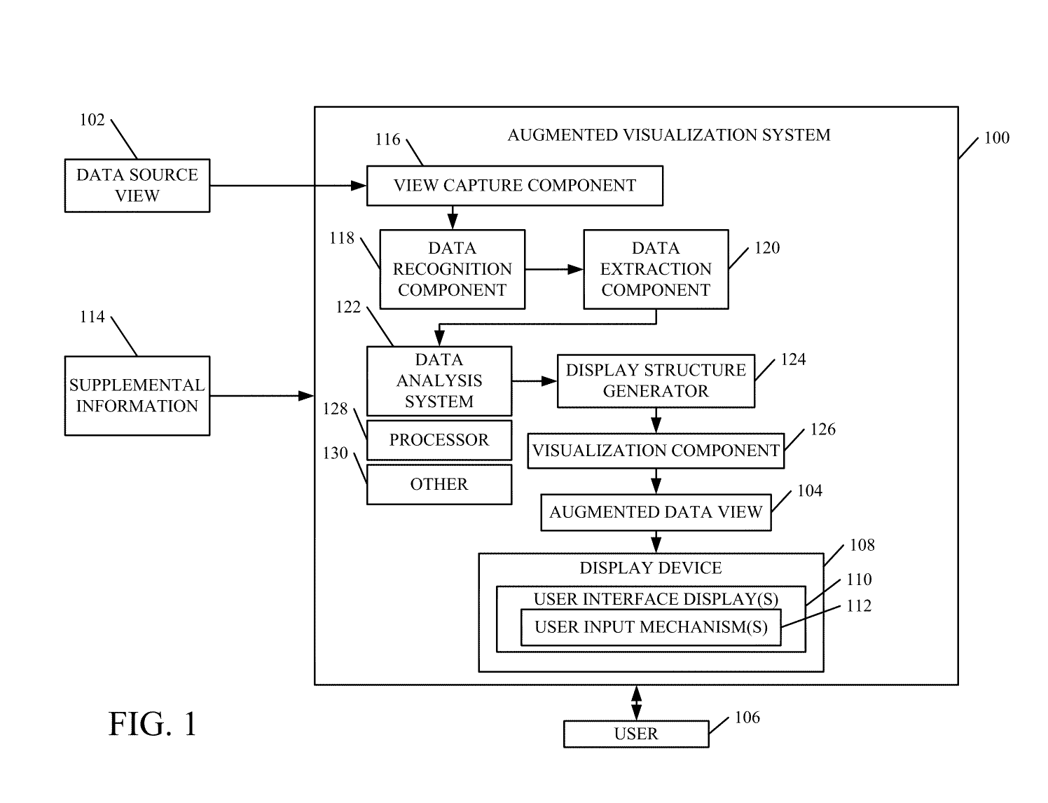

FIG. 1 is a block diagram of one example of augmented visualization system 100. System 100 illustratively receives a data source view 102 of data and generates an augmented data view 104 that is displayed to user 106 on a display device 108. The display device 108 illustratively displays user interface displays 110 with user input mechanisms 112 for interaction by user 106. User 106 illustratively interacts with user input mechanisms 112 (or with other user input mechanisms) to control and manipulate augmented visualization system 100. In the example shown in FIG. 1, system 100 also has access to supplemental information 114.

Augmented visualization system 100 can include view capture component 116, data recognition component 118, data extraction component 120, data analysis system 122, display structure generator 124, visualization component 126, computer processor 128, and it can include other items 130 as well. Before describing the overall operation of system 100 in more detail, a brief overview will first be provided.

In one embodiment, part or all of system 100 can be deployed on a mobile device (such as a smart phone, a tablet computer, etc.). Data source view 102 can be a wide variety of different sources, such as a display on a desktop device or in a slide presentation, an item of printed material, or a variety of other sources. View capture component 116 can be a camera on the mobile device that deploys system 100. Therefore, in one embodiment, user 106 captures an image of the data source view (such as by taking a picture of the desktop display screen, the slide presentation screen, the printed material, etc.). That image is provided to data recognition component 118 that performs data recognition (such as optical character recognition) on the image to recognize the content therein. Data extraction component 120 extracts that data into a meaningful structure (such as a table or other structure) and data analysis system 122 performs data analysis on the extracted data. System 122 can perform calculations, derivations, transformations, it can recognize patterns, or it can perform a wide variety of other analysis on the extracted data. Display structure generator 124 generates a display structure in which the results of the analysis can be displayed. Visualization component 126 generates an augmented data view 104 that includes at least portions of the results of the analysis performed by data analysis system 122, and provides augmented data view 104 to display device 108. The augmented data view is displayed for user 106.

In one example, data analysis system 122 can access supplemental information 114 as well. There may be multiple different types of supplemental information. A first type can come from the data source in a way that might not be captured by the camera. For example, the camera can pick up what is on-screen, but a network connection can allow a spreadsheet application to feed additional data to data analysis system 122.

A second type of supplemental information can be external, and data analysis system 122 can use search technology to intuit meaning and relationships in the data 102, for example. Or, as another example, it can leverage corporate rules and policy to identify data 102 that should be highlighted or flagged. These are only two examples. More examples are discussed below and a wide variety of others can be used as well. Therefore, user 106 can view not only the data source view 102 (such as on the user's desktop computer), but user 106 can also view the augmented data view 104 (which may have a wide variety of augmentations displayed) on the display device 108 of the user's mobile device.

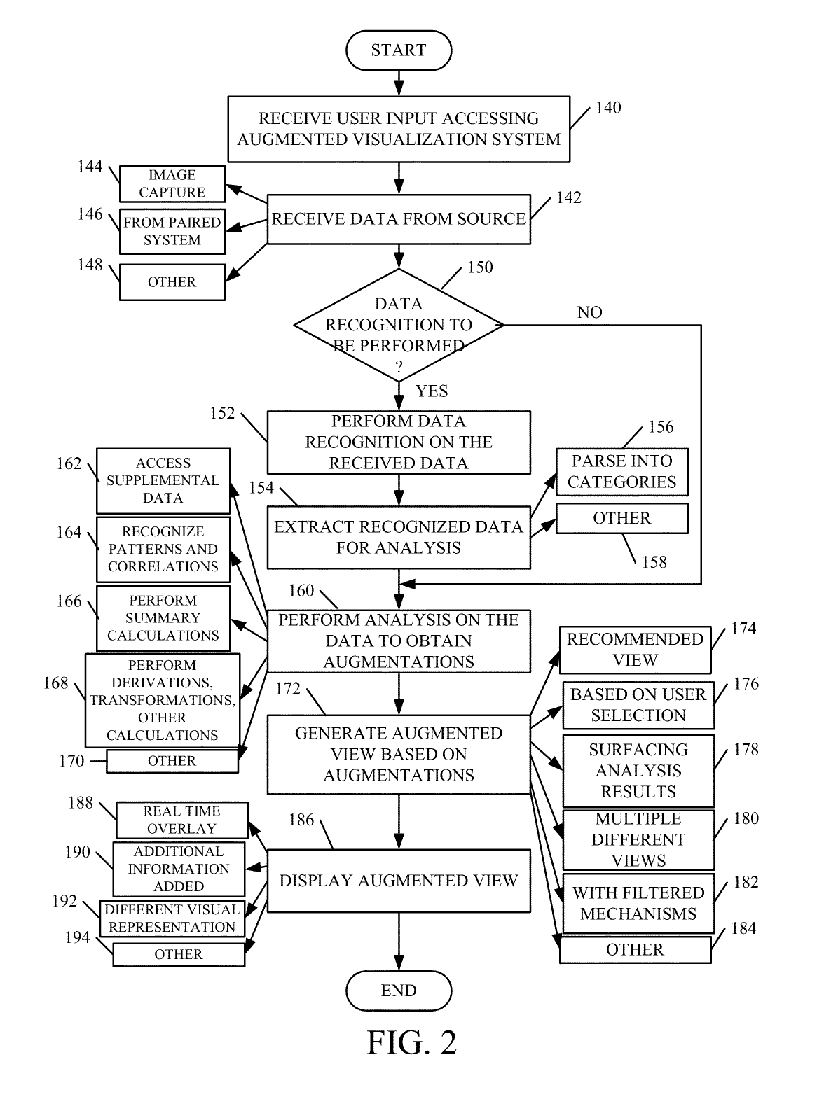

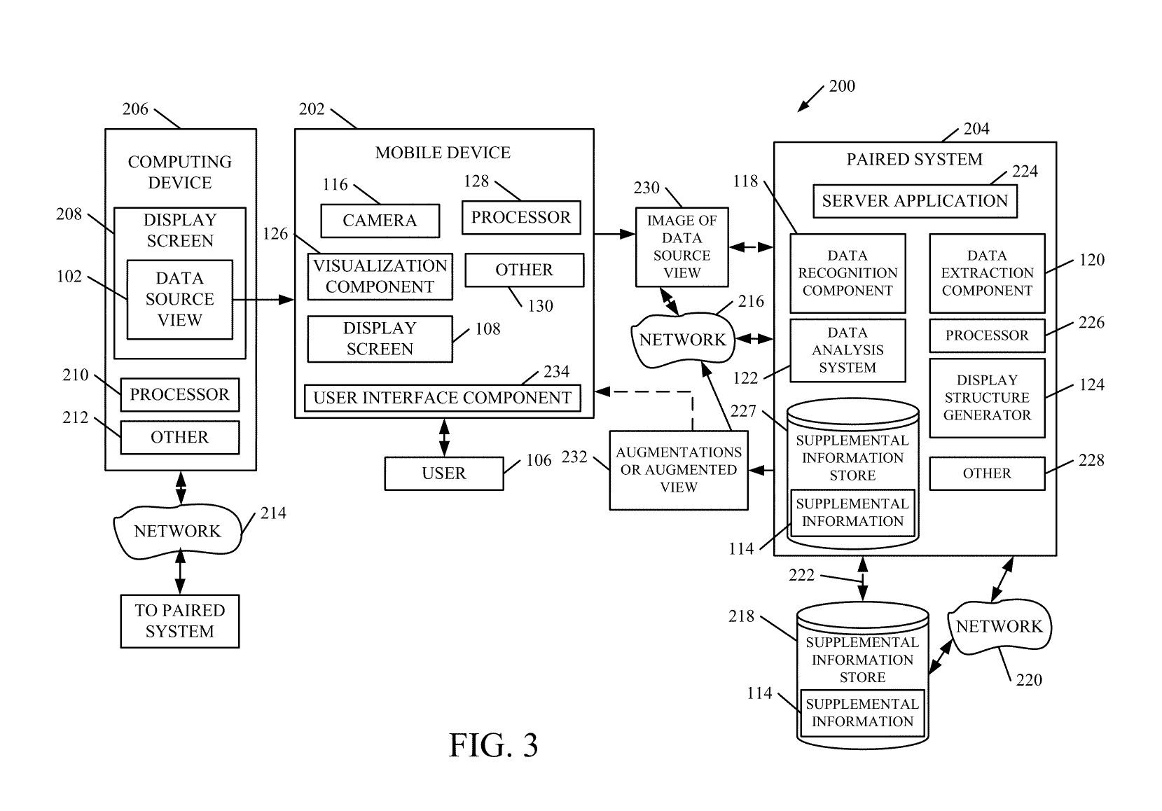

FIG. 2 is a flow diagram illustrating one example of the operation of augmented visualization system 100 in more detail. FIG. 2 will be described with respect to the example of augmented visualization system 100 shown in FIG. 1. It will be appreciated, however, that system 100 can be arranged in a different architecture, such as in a distributed architecture described below with respect to FIG. 3. Therefore, while FIG. 2 is described with respect to the architecture shown in FIG. 1, the description of FIG. 2 is equally applicable to other architectures, where functions performed in the augmented visualization system are distributed among other devices as well.

Augmented visualization system 100 first receives user inputs accessing augmented visualization system 100. This is indicated by block 140 in FIG. 2. This can be done in a wide variety of different ways. For instance, user 106 can provide user inputs on the user's mobile device in order to launch augmented visualization system 100, or in order to otherwise access it.

Once system 100 has been accessed, it receives data from the data source view 102. This is indicated by block 142 in FIG. 2. This can be done using an image capture device (such as the camera on the user's mobile device, or another image capture device). This is indicated by block 144. As is described in greater detail below, the data from the data source can be received in other ways as well, such as from a paired system 146. Further, the data can be received from the data source in other ways, and this is indicated by block 148.

Once the data is received, augmented visualization system 100 determines whether data recognition is to be performed on the data. This is indicated by block 150. Data recognition can include a number of different types of recognition. For instance, it can include text recognition (for example using optical or other character recognition). It can also include structural recognition (such as recognizing rows, columns, groupings and other types of structural relationships). It may also include certain kinds of interpretation (such as identifying numbers, currencies, dates, times, and other kinds of values).

For instance, if the data is received as an image captured by image capture component 116, then, in order to perform analysis on the data, the content of the data will be recognized. Thus, the data is provided to data recognition component 118 which can, for example, be an optical character recognition system. Data recognition system 118 performs character recognition on the received data so that the content of the data can be analyzed. Performing character recognition on the received data is indicated by block 152 in FIG. 2.

Once the content is recognized, data extraction component 120 can extract the recognized data for analysis. This is indicated by block 154 in FIG. 2. For instance, it can be parsed into categories, as indicated by block 156. It can also be placed into a predefined structure, such as a table, a form, or a variety of other structures. It can be extracted for analysis in other ways as well, and this is indicated by block 158.

Data analysis system 122 then performs analysis on the data to obtain augmentations. This is indicated by block 160. Data analysis system 122 can perform analysis by accessing supplemental data 162. Therefore, if the data is initially captured by capturing an image of a display screen on the user's desktop computer, for instance, then analysis system 122 may obtain additional or supplemental information in addition to the captured information. By way of example, it may be that the user is viewing a relatively large spreadsheet on his or her desktop computer. It may be so large that only a portion of the spreadsheet can be shown on the display device for the user's desktop computer. Therefore, when the user captures an image of the display screen, that is only a portion of the spreadsheet that the user is viewing. In that case, data analysis system 122 can obtain the identity of the spreadsheet from the content of the spreadsheet itself, from a user designation input, or in any other way, and data analysis system 122 can access (e.g., download) the entire spreadsheet as supplemental information 114, and use the data in the entire spreadsheet for analysis.

Data analysis system 122 can also access supplemental information 114 in other ways. For instance, where the content of the information is incomplete for certain types of analysis, data analysis system 122 can perform searching over a network (such as a wide area network or local area network) to obtain supplemental information that can be used to complete the analysis. Also, where the content of the data is from an image of a slide the user is viewing during a slide presentation, the presenter may provide a link to the entire presentation or to the supporting documents, and they can be accessed (as supplemental information 114) using the link provided. Supplemental information 114 can be obtained in a wide variety of other ways as well.

Data analysis system 122 can perform a wide variety of different types of analysis. For instance, it can recognize patterns and correlations in the data. This is indicated by block 164. It can perform summary calculations, as indicated by block 166. By way of example, if the data is numeric data arranged in a table, then data analysis system 122 can calculate sums, averages, counts, or a wide variety of other summary information.

Data analysis system 122 can also perform a wide variety of derivations, transformations, and other calculations. This is indicated by block 168. For instance, it can identify and highlight outlier values in the data set being analyzed. It can identify and highlight local or global minima or maxima. It can transform data from one domain (such as the frequency domain) to another (such as the time domain). It can perform a wide variety of other analysis derivations, aggregations, transformations or other calculations. This is indicated by block 170. In one example, the user can select the type of analysis to be performed. In another example, the types of analysis are automatically selected by the system based on default settings, based on the type of data, the type of data structure, user preferences or user history, or a variety of other criteria, some of which are mentioned below.

Display structure generator 124 then identifies a display structure for displaying the results of the analysis. For instance, based upon the type of information being analyzed, user inputs or the results of the analysis (or other things), the display structure may be identified as a bar chart, a pie chart, a tabular display, a pivot table, or a wide variety of other display structures. Visualization component 126 then generates the augmented view (including at least some aspects of the data analysis) using one or more display structures identified by display structure generator 124. Generating the augmented view is indicated by block 172 in FIG. 2.

In one example, visualization component 126 generates one or more recommended views, as indicated by block 174. It can also generate certain views based on user selection. This is indicated by block 176. For instance, when the user initially captures the data, the user may actuate an input mechanism indicating that the user wishes to have a certain type of chart view, or have the source data sorted based on certain filter criteria, or based on other user selections.

The augmented view illustratively surfaces some aspects of the analysis results, as indicated by block 178. The visualization component 126 can also generate a plurality of different augmented views as indicated by block 180. For instance, visualization component 126 can generate the same data in a bar chart view, and in a pie chart view or a histogram. It can also generate the same type of view (e.g., a bar chart) for different types of analysis results. By way of example, the data analysis system 122 may calculate averages, totals, counts, etc. Visualization component 126 can generate an augmented visualization for each of those different calculated analysis results. One or more of the augmented displays can be displayed to the user, with a user input mechanism that allows the user to switch between different augmented displays.

In another example, the augmented display is provided with filter input mechanisms, as indicated by block 182. This allows the user to filter the augmented display, using those mechanisms.

It will also be recognized, of course, that the augmented display can be generated in a wide variety of other ways as well. This is indicated by block 184.

Once visualization component 126 generates the augmented display (or augmented data view), display device 108 renders or displays the augmented view for the user. This is indicated by block 186. This can also be done in a wide variety of different ways. For instance, the augmented view can be a real time overlay that is superimposed or otherwise overlaid over a real time video image that the user is seeing through the user's camera lens. This is indicated by block 188.

In one example, it can incorporate video processing that adjusts the image so that it matches (in real-time) the live video stream. This can include special effect imaging that manipulates the video stream in such a way that it looks like a live stream, but the content is seamlessly modified. In another example, visualizations are added to the video stream that do not exist in the source material, but appear to be there in the augmented video. In another example, the augmented view can appear as if the video has been patched, with visualizations imposed on the top of it like stickers. Thus, the augmented view can be a single static image. However, it can also use the real-time video stream to selectively inject visualizations and/or additional data in the right locations, so the visualizations look natural, as if they were part of the original material. This may include choosing fonts and colors and styles (etc.) to fit seamlessly with the original content.

The augmented display can display additional information over what the user is actually seeing, or over a snapshot image of the source data. For instance, if the user captures an image of a table of values, the augmented display may include column totals that are displayed beneath the columns in the captured image of the table. Displaying additional information in addition to the source data is indicated by block 190 in FIG. 2.

The augmented display can also be a completely different visual representation of the captured source data than the one originally captured. This is indicated by block 192. For instance, the user may capture the source data in tabular form, and the augmented display may be a bar chart. Thus, the augmented display may completely replace the original view of the data, as originally captured, or as originally received.

The augmented display can take a wide variety of other forms as well. This is indicated by block 194 in FIG. 2.

FIG. 3 shows augmented visualization system 100 deployed in a paired device architecture 200. Paired device architecture 200 includes mobile device 202 that is paired with a paired system 204 (such as a server). Architecture 200 also illustratively includes another computing device 206, which may be the user's desktop computer, for example. In the example shown in FIG. 3, similar items to those shown in FIG. 1 are similarly numbered.

In the example shown in FIG. 3, computing device 206 includes a display screen 208 that displays the data source view 102. Device 206 also includes processor 210 and it can include other items 212 as well. It is connected to paired system 204 over network 214. Mobile device 202 can be connected to paired system 204 either directly, or over a network 216. Paired system 204 can be connected to an external supplemental information store 218 over network 220 or directly as indicated by arrow 222. It will be noted that store 218 can include more than just a store of supplemental information. It can be a processor of supplemental information. The data analysis system 122 can access it to have further analysis performed or to obtain the results of analysis already performed. It can also access it to obtain information such as stock price history or census demographics or other external information. It will be appreciated that networks 214, 216 and 220 can all be the same network, or they can be different networks.

Other items are also shown in FIG. 3. For instance, mobile device 202 includes user interface component 234. User interface component 234 illustratively generates and manages various aspects of user interface operations with user 106. Thus, user interface component 234 can receive touch inputs through a touch sensitive display screen, it can receive key or button inputs or a wide variety of other user inputs (some of which are discussed below) from user 106 as well. Paired system 204 includes server application 224, processor 226 and supplemental information store 227 that stores supplemental information 114. It can include other items 228 as well. Thus, processor 226 can be a server that is running server application 224 and hosting the application as a service for device 206 and/or device 202.

Paired system 204 illustratively runs a server application 224 that is accessed by computing device 206. For instance, where computing device 206 is generating data source view 102 that is a display of a portion of a spreadsheet, the spreadsheet application may be running as a server application 224 on paired system 204. It will be noted, however, that the application may be running on computing device 206 or on device 202 as well.

In one scenario, user 106 may be viewing the spreadsheet on display screen 208 on computing device 206. It may be that user 106 then desires to see an augmented view of the data on the display screen 208. In that case, user 106 illustratively uses the camera 116 on mobile device 202 to capture an image of data source view 102 from the screen 208 on device 206. Mobile device 202 then illustratively provides the image of the data source view (represented by number 230) to paired system 204. In the example shown in FIG. 3, paired system 204 includes data recognition component 118, data extraction component 120, data analysis system 122 and display structure generator 124. These items operate in a similar fashion as discussed above with respect to FIGS. 1 and 2. Therefore, they recognize the content in image 230, extract that content, perform various analysis steps on that content, and identify a display structure for displaying the results of the analysis (e.g., the augmentations). Paired system 204 then provides the augmentations (or an augmented view) 232 back to mobile device 202. Visualization component 126 uses user interface component 234 to generate an augmented display of the augmented view 232 on display screen 108.

It will be appreciated that architecture 200 is only one example of an architecture for implementing augmented visualization system 100. For instance, various components shown in paired system 204 can be on mobile device 202, and vice versa. Further, the various components of augmented visualization system 100 can be distributed among a plurality of different paired systems or other systems that are accessible by mobile device 100. They can be systems implemented as software as a service, infrastructure as a service, or a variety of other services. These are examples only.

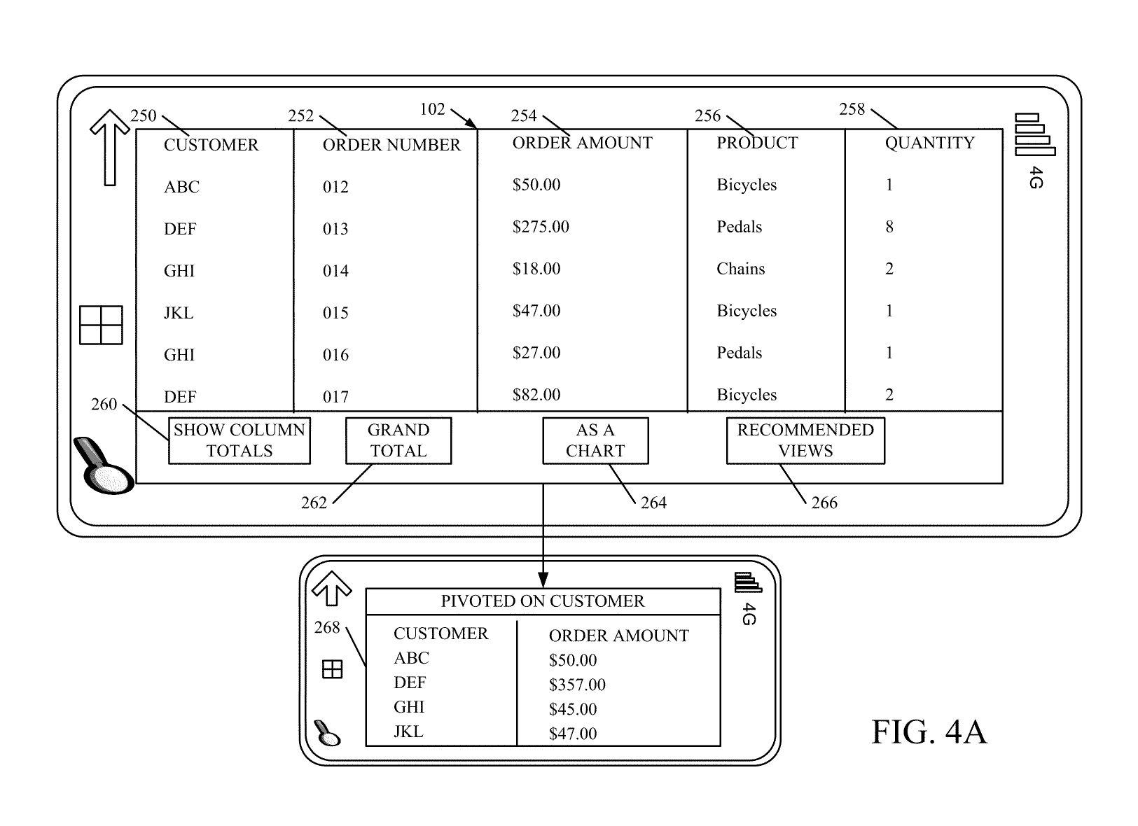

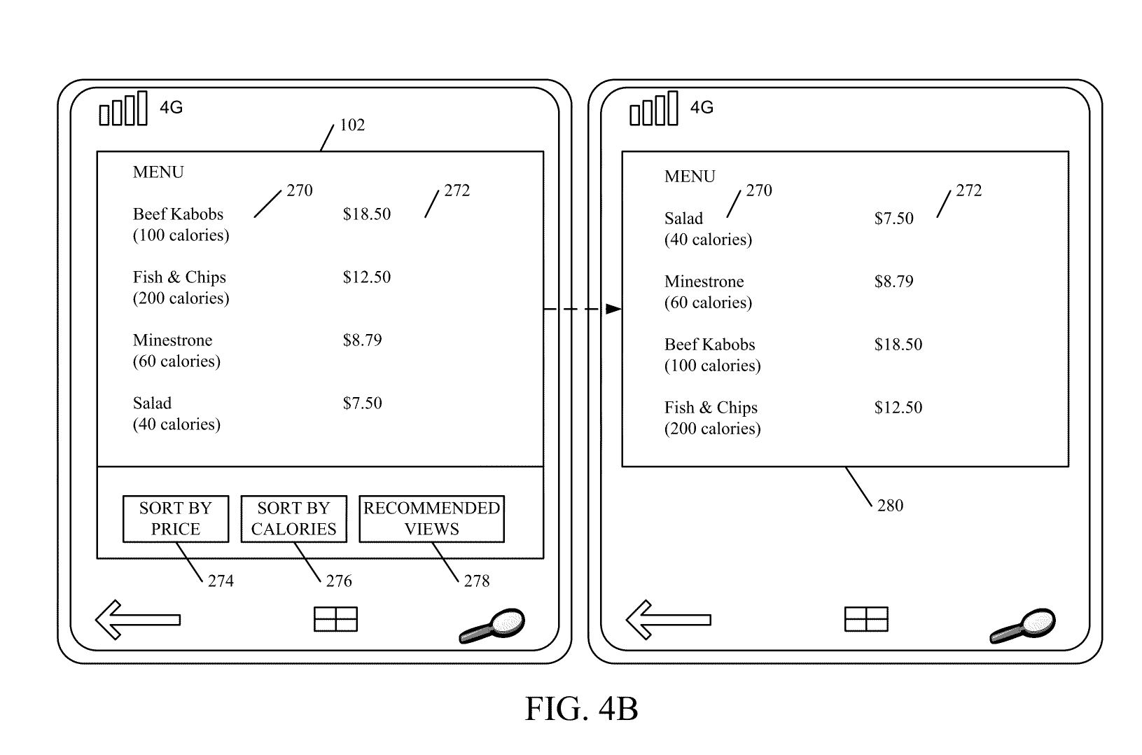

A number of examples will now be described. FIGS. 4A and 4B show an example of user interface displays.

FIG. 4A shows one example of a data source view 102. In the example shown in FIG. 4A, data source view 102 is a table that has a customer column 250, an order number column 252, an order amount column 254, a product column 256, and a quantity column 258. Data source view 102 may, for instance, be a portion of a spreadsheet or a business system form, or another view of data, displayed on the user's desktop computer, such as on computing device 206. In one example, user 106 uses camera 116 on mobile device 202 (such as a smart phone) to capture an image of data source view 102.

When the image is captured, mobile device 202 can display a plurality of user selectable input mechanisms that allow user 106 to select the type of augmented view that the user wishes to see. For instance, user input mechanism 260 allows the user to select an augmented view that would show column totals for numeric values. User input mechanism 262 allows user 106 to select an augmented view that would show grand totals. User input mechanism 264 allows user 106 to select an augmented view that shows the data in view 102 in chart format, and user input mechanism 266 allows user 106 to let augmented visualization system 100 recommend views based on various patterns or other correlations identified in the data in view 102.

FIG. 4A also shows one augmented view 268. It can be seen that augmented view 268 is a pivot table that pivots the information in view 102 based upon the customer and order amount. It totals the order amounts by customer. Thus, it can be seen that augmented view 268 can be displayed on the display screen 108 of mobile device 202, even while the original spreadsheet or other data source view 102 is still displayed on the display screen 208 of the user's desktop computing device 206. This allows user 106 to see different visualizations of the data, without replacing the original data source view.

In another example, however, the augmented view can show the original data source view 102, with augmented data added to that view. For instance, it may show the original data source view 102 with the order amount totaled at the bottom of column 254. It may also show the quantities totaled at the bottom of column 258. It can also show other augmented data based on other calculations performed by data analysis system 122. For instance, it may show the average order amount at the bottom of column 254, or the average number of orders per customer or the average quantity of items ordered per order number. These are examples only of the various augmented data that can be shown.

FIG. 4B shows yet another example of a data source view 102. In the example shown in FIG. 4B, data source view 102 is a paper menu that user 106 is viewing at a restaurant. It can be seen that the paper menu includes a set of food items 270, along with their prices 272. Each food item 270 also includes a calorie identifier identifying the number of calories for the corresponding food item. When the user captures data source view 102 using camera 116 on mobile device 202, augmented visualization system 100 can display user input mechanisms that allow the user to choose various types of augmented views that the user wishes to see. For instance, user input mechanism 274 allows the user to select an augmented view where the menu items 170 are sorted by price. User input mechanism 276 allows user 106 to select an augmented view where the menu items 270 are sorted based on calories. User input mechanism 278 allows user 106 to select an augmented view that is recommended by system 100.

FIG. 4B shows one example of an augmented view 280 where the user has selected the menu items 270 sorted by calories. It can be seen that data analysis system 112 has identified the calorie count for each menu item 270 based on the content in the captured image of the menu and display structure generator 124 has arranged a view in which the menu items 270 are displayed based on the number of calories, arranged in ascending order.

In another example, it may be that the menu did not show calorie amounts. In that case, data analysis system can do a search to find calories for the menu items and use the search results as supplemental information 114 for its analysis.

In yet another example, data analysis system 122 can access a search engine or social network information or other supplemental data sources to rate entrees and sort (or highlight) them by popularity. The augmented view can include this as well.

It will be appreciated that the augmented views shown in FIGS. 4A and 4B are examples only. A wide variety of different augmented views can be generated as well. For example, the augmented view can be generated as the user pans his or her camera across the original data source view 102. Thus, in that case, the augmented view is superimposed or otherwise overlaid on top of a real time video image that the user is seeing through his or her camera lens.

Other augmented views can be generated as well. For instance, assume that user 106 works at a factory where the work assignments for a period of time are posted. The user can capture an image of the posted work assignments, and data analysis system 122 can generate an augmented view which displays the hours user 106 works during the next work period, sorted by day. This augmented view thus extracts the user's work schedule information and generates an augmented view of the user's work schedule and displays it to user 106. It can also display it over a weekly or monthly calendar view, for instance. It can further analyze the user's take-home pay based on those hours and update and display a monthly budget that system 122 accesses, as supplemental information 114.

In another example, the user may have a paper document that shows a set of bus schedules or train schedules, in tabular form, for instance. User 106 can capture an image of that data, in tabular form, and data analysis system 122 can analyze the data so that display structure generator 124 can generate an augmented view showing travel times, using different buses or trains (or combinations thereof) arranged by source or by destination, or different variations thereof.

In another example, assume that a presenter is presenting information on a slide presentation. User 106 can capture an image of a given slide and data analysis system 122 illustratively surfaces various correlations and patterns in the displayed data, and displays an augmented view indicative of those patterns or correlations. This can be done in near real time so that user 106 can see these items during the presentation.

It will be appreciated that the examples discussed herein are examples only. A wide variety of other analysis steps can be performed on the data, and a wide variety of different augmented displays can be generated.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands. The “displays” can include or be comprised of audible or haptic user interface outputs as well. The input mechanisms can sense haptic or movement inputs (such as the user shaking or rotating a mobile device).

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

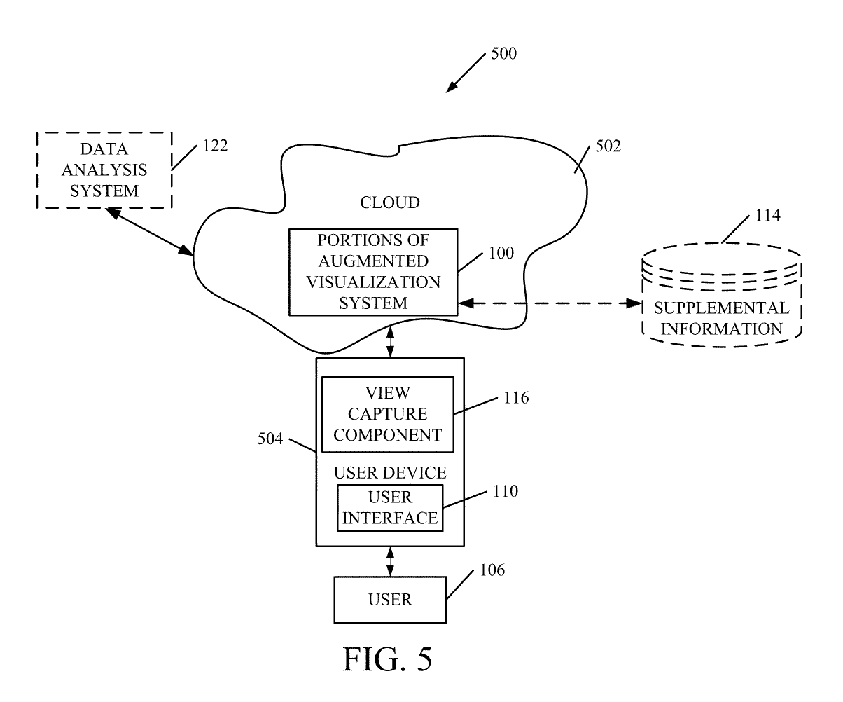

FIG. 5 is a block diagram of system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIGS. 1 and 3 and they are similarly numbered. FIG. 5 specifically shows that portions of system 100 can be located in cloud 502 (which can be public, private, or a combination where portions are public while others are private). Therefore, user 106 uses a user device 504 (which can be mobile device 202 or another device) to access those systems through cloud 502.

FIG. 5 also depicts another embodiment of a cloud architecture. FIG. 5 shows that it is also contemplated that some elements of system 100 can be disposed in cloud 502 while others are not. By way of example, supplemental information 114 can be disposed outside of cloud 502, and accessed through cloud 502. In another embodiment, data analysis system 122 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

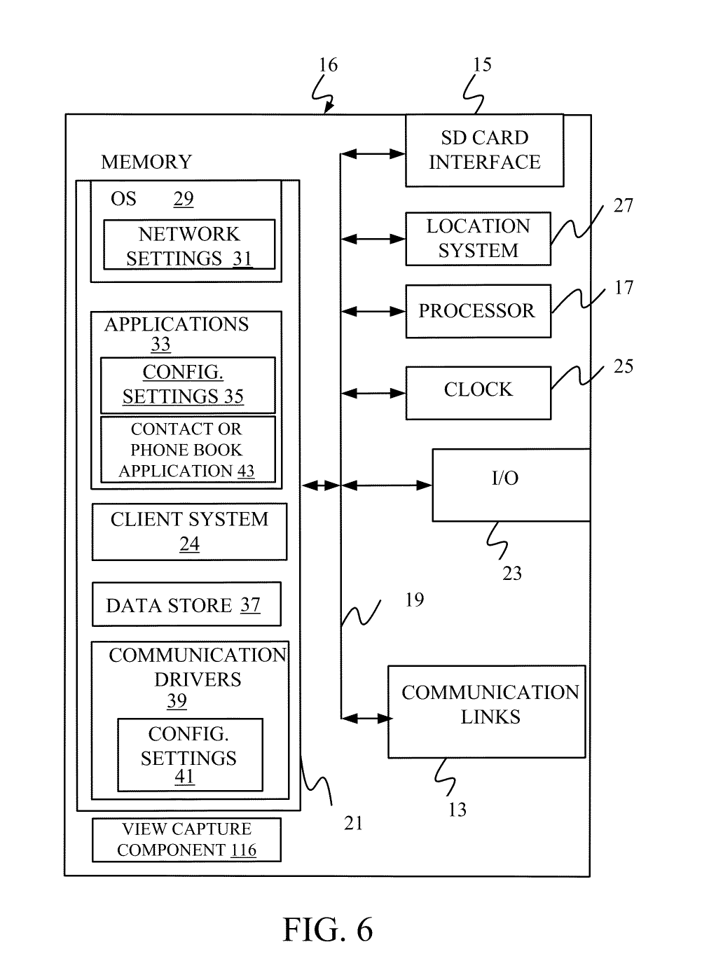

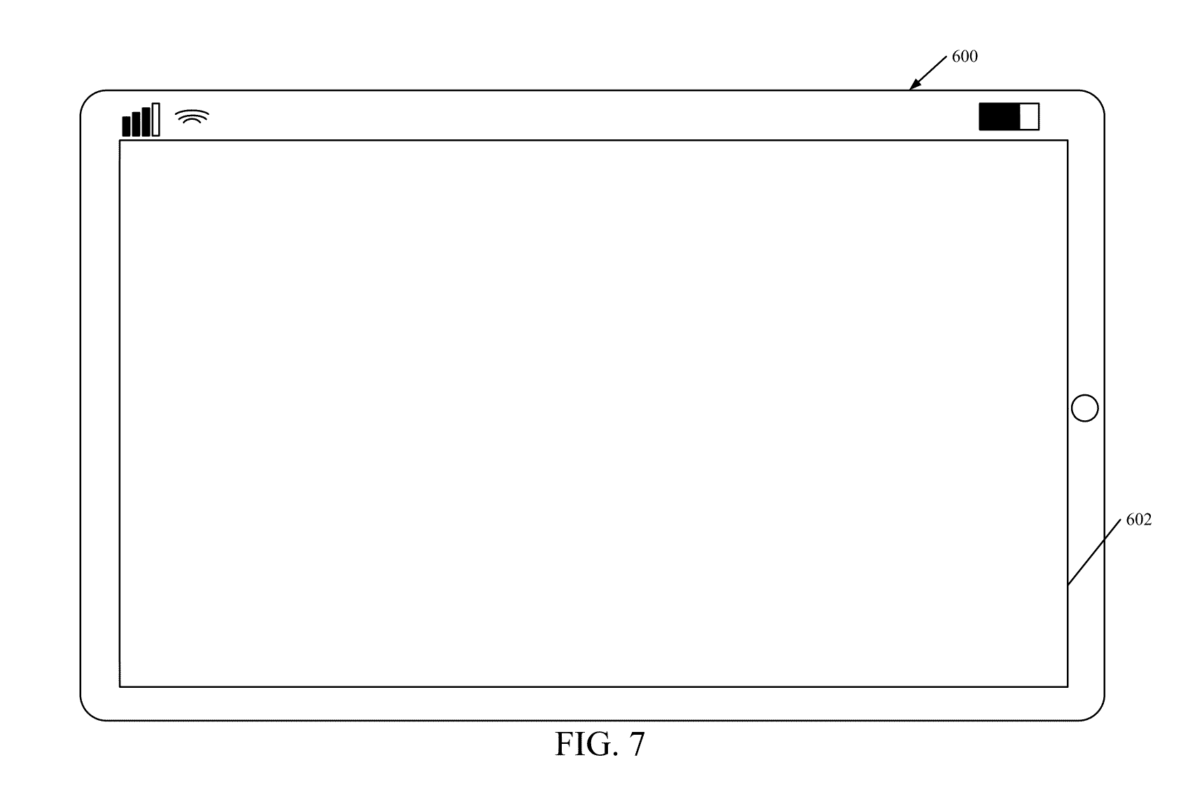

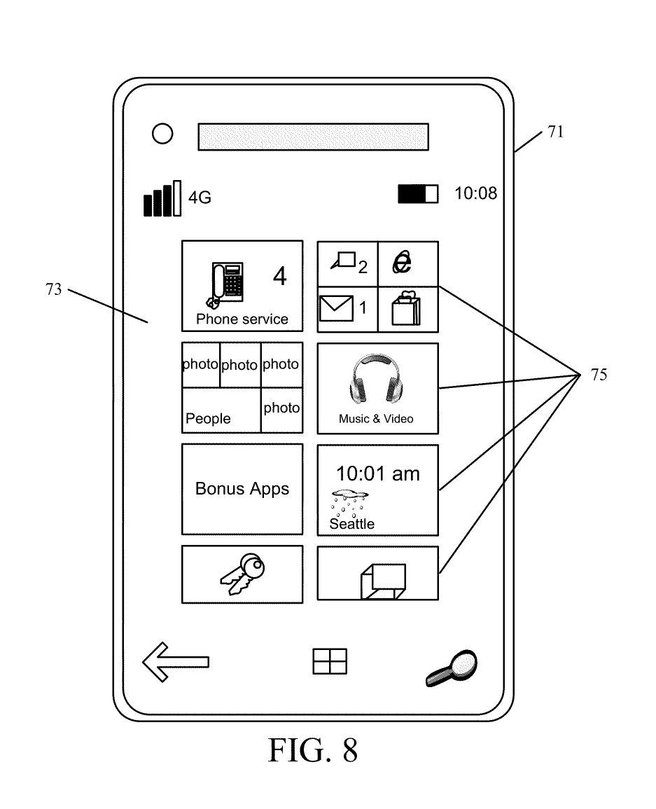

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices (that can comprise device 202, for instance).

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like OCR component 118 or data analysis system 122 or other portions of system 100) are received on a removable Secure Digital (SD) card that is connected to a SD card interface 15. SD card interface 15 and communication links 13 communicate with a processor 17 (which can also embody processors 128, 210, and 226 from FIG. 3) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, RFID readers, laser or other scanners, QR code readers, proximity sensors, microphones, tilt sensors, and gravity switches and output components such as a display device, a speaker, and or a printer port. View capture component 116 can be a camera, a video-camera, or a wide variety of other scanners, image capturing devices, or other such devices. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. A smart phone or mobile phone can be provided as the device 16. For instance, the phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device can also be a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows one example of a smart phone 71. Smart phone 71 has a touch sensitive display 73 that displays icons or tiles or other user input mechanisms 75. Mechanisms 75 can be used by a user to run applications, make calls, perform data transfer operations, take pictures or videos etc. In general, smart phone 71 is built on a mobile operating system and offers more advanced computing capability and connectivity than a feature phone.

Note that other forms of the devices 16 are possible.

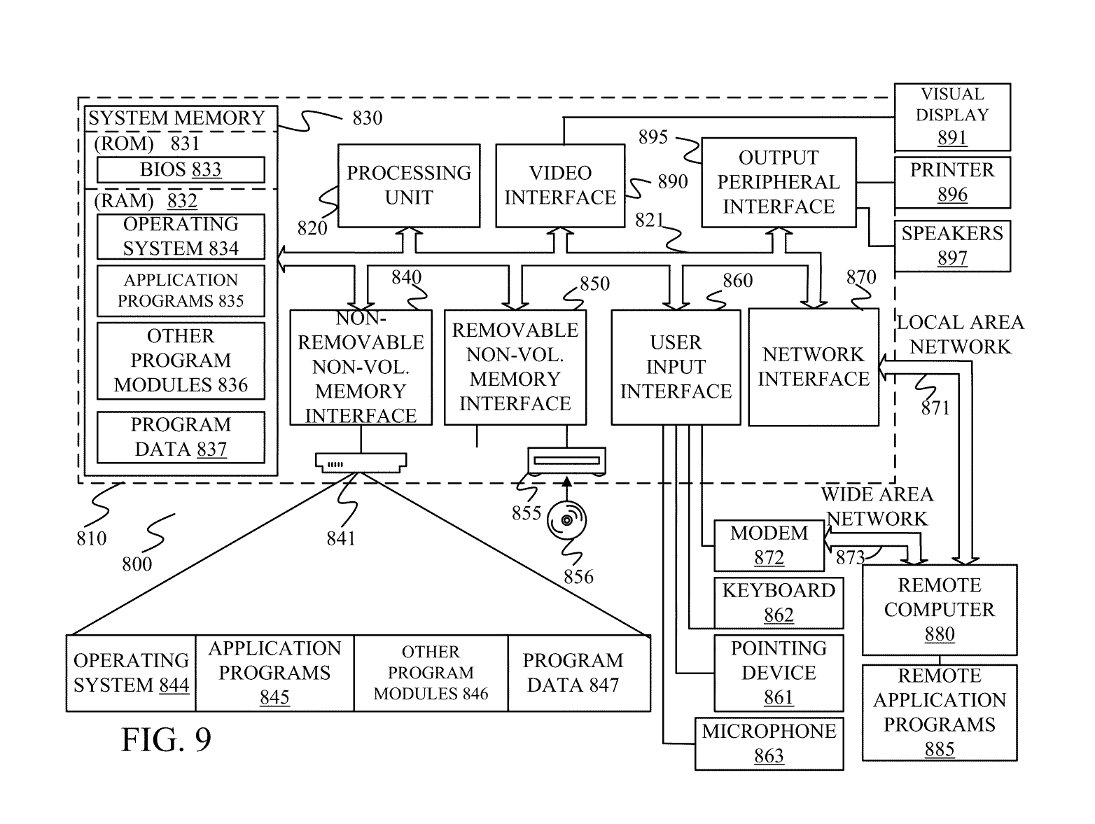

FIG. 9 is one embodiment of a computing environment in which system 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 128, 210 or 226), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

A first example is a computer-implemented method, comprising:

receiving an image of structured data on a mobile device;

obtaining data summary augmentations based on content of the structured data; and

generating a visual display of the data summary augmentations.

A second example is the computer-implemented method of any or all previous examples and further comprising:

accessing supplemental data, based on the structured data, the summary augmentations being based on the content of the structured data and the supplemental data.

A third example is the computer-implemented method of any or all previous examples wherein accessing supplemental data comprises:

accessing the supplemental data from a paired machine.

A fourth example is the computer-implemented method of any or all previous examples wherein obtaining data summary augmentations comprises:

recognizing the content in the image of the structured data;

performing analysis on the content; and

calculating the data summary augmentations based on the analysis.

A fifth example is the computer-implemented method of any or all previous examples wherein obtaining data summary augmentations comprises:

sending the structured data to a remote server; and

receiving the data summary augmentations, indicative of analysis performed at the remote server.

A sixth example is the computer-implemented method of any or all previous examples wherein receiving an image of structured data comprises:

capturing the image using a camera on the mobile device.

A seventh example is the computer-implemented method of any or all previous examples wherein generating a visual display comprises:

generating a plurality of different, user-selectable views; and

displaying a user selection mechanism for selecting, for display, one of the plurality of different, user-selectable views.

An eighth example is the computer-implemented method of any or all previous examples wherein receiving the image comprises receiving the image in a first structure and wherein generating the visual display comprises:

generating an augmented visual display that augments the first structure with the data summary augmentations.

A ninth example is the computer-implemented method of any or all previous examples wherein generating the augmented visual display comprises:

displaying the visual indication of the augmented data over the first structure.

A tenth example is the computer-implemented method of any or all previous examples wherein receiving the image comprises receiving the image of structured data in a first structure and wherein generating the visual display comprises:

generating the visual display in a second structure, different from the first structure.

An eleventh example is the computer-implemented method of any or all previous examples wherein receiving the image of structured data comprises receiving the image of structured data in a tabular structure, and wherein generating the visual display in a second structure comprises:

displaying a chart or graph representation of the structured data.

A twelfth example is a mobile device, comprising:

an image capture component that receives an image of structured data;

a visualization component that generates a user interface display showing analysis result data indicative of analysis performed on content of the structured data;

a display device that displays the user interface display; and

a computer processor that is a functional part of the mobile device and is activated by the image capture component and the visualization component to facilitate receiving the image of structured data and generating the user interface display.

A thirteenth example is the mobile device of any or all previous examples wherein the image capture component comprises:

a camera that captures the image of structured data as tabular data.

A fourteenth example is the mobile device of any or all previous examples wherein the visualization component generates a graph or chart representation of the tabular data.

A fifteenth example is the mobile device of any or all previous examples wherein the visualization component generates the user interface display as including the image of structured data augmented with additional summary data summarizing the structured data.

A sixteenth example is the mobile device of any or all previous examples wherein the visualization component generates the user interface display to show patterns in the content of the structured data.

A seventeenth example is the mobile device of any or all previous examples wherein the visualization component generates the user interface display to show correlations in the content of the structured data.

A eighteenth example is the mobile device of any or all previous examples wherein the image capture component receives the image of structured data by capturing the image from a display device of a computing device.

A nineteenth example is a computer readable storage medium that stores computer executable instructions which, when executed by a mobile computing device, cause the mobile computing to perform a method, comprising:

receiving an image of tabular data;

obtaining additional information based on content of the tabular data, the additional information being indicative of patterns in the content of the tabular data; and

generating a visual display of the additional information.

A twentieth example is the computer readable storage medium of any or all previous examples wherein obtaining additional information comprises:

obtaining the content of the tabular data from the image;

sending the content to a remote service for analysis; and

receiving, as the additional information, analysis results from the remote service.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving an image of structured data on a mobile device;
obtaining data summary augmentations based on content of the structured data; and
generating a visual display of the data summary augmentations.

2. The computer-implemented method of claim 1 and further comprising:
accessing supplemental data, based on the structured data, the summary augmentations being based on the content of the structured data and the supplemental data.

3. The computer-implemented method of claim 2 wherein accessing supplemental data comprises:
accessing the supplemental data from a paired machine.

4. The computer-implemented method of claim 1 wherein obtaining data summary augmentations comprises:
recognizing the content in the image of the structured data;
performing analysis on the content; and
calculating the data summary augmentations based on the analysis.

5. The computer-implemented method of claim 1 wherein obtaining data summary augmentations comprises:
sending the structured data to a remote server; and
receiving the data summary augmentations, indicative of analysis performed at the remote server.

6. The computer-implemented method of claim 1 wherein receiving an image of structured data comprises:
capturing the image using a camera on the mobile device.

7. The computer-implemented method of claim 1 wherein generating a visual display comprises:
generating a plurality of different, user-selectable views; and
displaying a user selection mechanism for selecting, for display, one of the plurality of different, user-selectable views.

8. The computer-implemented method of claim 1 wherein receiving the image comprises receiving the image in a first structure and wherein generating the visual display comprises:
generating an augmented visual display that augments the first structure with the data summary augmentations.

9. The computer-implemented method of claim 8 wherein generating the augmented visual display comprises:
displaying the visual indication of the augmented data over the first structure.

10. The computer-implemented method of claim 1 wherein receiving the image comprises receiving the image of structured data in a first structure and wherein generating the visual display comprises:
generating the visual display in a second structure, different from the first structure.

11. The computer-implemented method of claim 10 wherein receiving the image of structured data comprises receiving the image of structured data in a tabular structure, and wherein generating the visual display in a second structure comprises:
displaying a chart or graph representation of the structured data.

12. A mobile device, comprising:
an image capture component that receives an image of structured data;
a visualization component that generates a user interface display showing analysis result data indicative of analysis performed on content of the structured data;
a display device that displays the user interface display; and
a computer processor that is a functional part of the mobile device and is activated by the image capture component and the visualization component to facilitate receiving the image of structured data and generating the user interface display.

13. The mobile device of claim 12 wherein the image capture component comprises:
a camera that captures the image of structured data as tabular data.

14. The mobile device of claim 13 wherein the visualization component generates a graph or chart representation of the tabular data.

15. The mobile device of claim 12 wherein the visualization component generates the user interface display as including the image of structured data augmented with additional summary data summarizing the structured data.

16. The mobile device of claim 12 wherein the visualization component generates the user interface display to show patterns in the content of the structured data.

17. The mobile device of claim 12 wherein the visualization component generates the user interface display to show correlations in the content of the structured data.

18. The mobile device of claim 12 wherein the image capture component receives the image of structured data by capturing the image from a display device of a computing device.

19. A computer readable storage medium that stores computer executable instructions which, when executed by a mobile computing device, cause the mobile computing to perform a method, comprising:
receiving an image of tabular data;
obtaining additional information based on content of the tabular data, the additional information being indicative of patterns in the content of the tabular data; and
generating a visual display of the additional information.

20. The computer readable storage medium of claim 19 wherein obtaining additional information comprises:
obtaining the content of the tabular data from the image;
sending the content to a remote service for analysis; and
receiving, as the additional information, analysis results from the remote service.
